(19) United States
(12) Patent Application Publication
(10) Pub. No.: US 2023/0289898 A1
(43) Pub. Date: Sep. 14, 2023

(54) INFORMATION PROCESSING SYSTEM, INFORMATION PROCESSING METHOD AND PROGRAM

(71) Applicant: RAKUTEN GROUP, INC., Tokyo (JP)

(72) Inventors: Satyen ABROL, Setagaya-ku, Tokyo (JP); Manoj KONDAPAKA, Setagaya-ku, Tokyo (JP); Kenichiro YAMADA, Setagaya-ku, Tokyo (JP)

(21) Appl. No.: 17/928,606

(22) PCT Filed: Dec. 22, 2021
(86) PCT No.: PCT/JP2021/047626

§ 371 Date: Nov. 29, 2022

(51) Int. Cl. G06Q 50/00

(52) U.S. Cl. CPC G06Q 50/01

(57) ABSTRACT

An information processing system identifies a type of a relation between a person of interest and a reference person; determines, in accordance with a determination criterion corresponding to the type of the relation between the person of interest and the reference person, a proximity score indicating a proximity between the person of interest and the reference person based on an index indicating a strength of a relationship between the person of interest and the reference person; and estimates an update necessity of personal information on the person of interest based on input data including an attribute of the person of interest, an attribute of the reference person, a change status of personal information on the reference person, and the proximity score and the type of the relation for a pair of the person of interest and the reference person.

### TECHNICAL FIELD

The present invention relates to an information processing system, an information processing method, and a program.

### BACKGROUND ART

Personal information is used when various services are provided. A service provider acquires the personal information on a user from the user, and uses a street address, a telephone number, and the like included in the personal information to provide a required service.

In JP 2020-035093 A, it is disclosed that a change in lifestyle is estimated based on an operation log of a home appliance, and when it is estimated that there has been a change in lifestyle, a request to update the personal information is transmitted to an information processing terminal of the user.

### SUMMARY OF INVENTION

### Technical Problem

Some personal information, for example, the street address, may differ from the actual information over time. Meanwhile, users sometimes do not update their personal information for a service provider even when there is a difference between the personal information and the actual information. As a result, a user may be inconvenienced due to some kind of problem occurring in the provision of the service, such as a document sent by postal mail not reaching the user. Further, when the service provider frequently confirms a change status of the personal information, there is a burden on the user.

The present invention has been made in view of the above-mentioned problems, and has an object to provide a technology for enabling a situation in which personal information held by a service provider has not been updated to be handled more appropriately.

### Solution to Problem

According to one embodiment of the present invention, there is provided an information processing system including: relation identification means for identifying a type of a relation between a person of interest and a reference person; proximity score determination means for determining, in accordance with a determination criterion corresponding to the type of the relation between the person of interest and the reference person, a proximity score indicating a proximity between the person of interest and the reference person based on an index indicating a strength of a relationship between the person of interest and the reference person; and update necessity estimation means for estimating an update necessity of personal information on the person of interest based on input data including an attribute of the person of interest, an attribute of the reference person, a change status of personal information on the reference person, and the proximity score and the type of the relation for a pair of the person of interest and the reference person.

According to one embodiment of the present invention, there is provided an information processing method including the steps of: identifying a type of a relation between a person of interest and a reference person; determining, in accordance with a determination criterion corresponding to the type of the relation between the person of interest and the reference person, a proximity score indicating a proximity between the person of interest and the reference person based on an index indicating a strength of a relationship between the person of interest and the reference person; and estimating an update necessity of personal information on the person of interest based on input data including an attribute of the person of interest, an attribute of the reference person, a change status of personal information on the reference person, and the proximity score and the type of the relation for a pair of the person of interest and the reference person.

According to one embodiment of the present invention, there is provided a program for causing a computer to function as: relation identification means for identifying a type of a relation between a person of interest and a reference person; proximity score determination means for determining, in accordance with a determination criterion corresponding to the type of the relation between the person of interest and the reference person, a proximity score indicating a proximity between the person of interest and the reference person based on an index indicating a strength of a relationship between the person of interest and the reference person; and update necessity estimation means for estimating an update necessity of personal information on the person of interest based on input data including an attribute of the person of interest, an attribute of the reference person, a change status of personal information on the reference person, and the proximity score and the type of the relation for a pair of the person of interest and the reference person.

In one aspect of the present invention, the update necessity estimation means may be configured to estimate the update necessity by inputting the input data to an update necessity estimation model, which is a machine learning model trained by using training data including an attribute of a first person, an attribute of a second person, the type of the relation and the proximity score for a pair of the first person and the second person, a change status of personal information on the second person, and ground truth data indicating whether personal information on the first person has been changed.

In one aspect of the present invention, the relation identification means may be configured to select any one candidate from among candidates including at least part of parent-child, spouse, and sibling as the type of the relation.

In one aspect of the present invention, the relation identification means may be configured to identify the type of the relation between the person of interest and the reference person based on at least part of whether a surname is the same, whether an IP address is the same, a similarity in street addresses, an age difference, and whether gender is the same.

In one aspect of the present invention, the proximity score determination means may be configured to determine the proximity score indicating the proximity between the person of interest and the reference person based on an output of a proximity score determination model, which is a machine learning model corresponding to the type of the relation between the person of interest and the reference person, the output obtained when the index indicating the strength of the relationship between the person of interest and the reference person is input to the proximity score determination model.

In one aspect of the present invention, the index indicating the strength of the relationship between the person of interest and the reference person may include at least part of whether the person of interest and the reference person have a same street address, whether the person of interest and the reference person share a credit card, a number of friends in common between the person of interest and the reference person, a frequency of phone calls between the person of interest and the reference person, and a frequency of sending gifts between the person of interest and the reference person.

In one aspect of the present invention, the relation identification means may be configured to identify the type of the relation between the person of interest and the reference person based on attribute data of the person of interest registered in a first computer system and attribute data of the reference person registered in a second computer system.

### Advantageous Effects of Invention

According to the present invention, the situation in which the personal information held by the service provider has not been updated can be handled more appropriately.

### BRIEF DESCRIPTION OF DRAWINGS

FIG. 1 is a diagram for illustrating an example of an overall configuration of an information processing system according to one embodiment of the present invention.

FIG. 2 is a functional block diagram for illustrating an example of functions of the information processing system according to the one embodiment of the present invention.

FIG. 3 is a diagram for schematically illustrating an example of common IP address data values.

FIG. 4 is a diagram for illustrating an example of graph data.

FIG. 5 is a diagram for schematically illustrating an example of common street address data values.

FIG. 6 is a diagram for illustrating an example of graph data.

FIG. 7 is a diagram for schematically illustrating an example of common credit card number data values.

FIG. 8 is a diagram for illustrating an example of graph data.

FIG. 9 is a diagram for illustrating an example of graph data.

FIG. 10 is a diagram for illustrating an example of clusters.

FIG. 11 is a diagram for illustrating an example of classification visualization.

FIG. 12 is a diagram for illustrating an example of determination of a proximity score by using a machine learning model.

FIG. 13 is a diagram for illustrating an example of training of a machine learning model.

FIG. 14 is a flow chart for illustrating an example of processing relating to creation of a social graph performed by the information processing system according to the one embodiment of the present invention.

FIG. 15 is a flow chart for illustrating an example of processing of a learning module performed by the information processing system according to the one embodiment of the present invention.

FIG. 16 is a flow chart for illustrating an example of processing of an estimation module performed by the information processing system according to the one embodiment of the present invention.

### DESCRIPTION OF EMBODIMENTS

Description is given below in detail of one embodiment of the present invention with reference to the drawings. In this embodiment, description is given of an information processing system 1 that detects and handles a user having personal information which is required to be changed due to, for example, moving house but has not been updated.

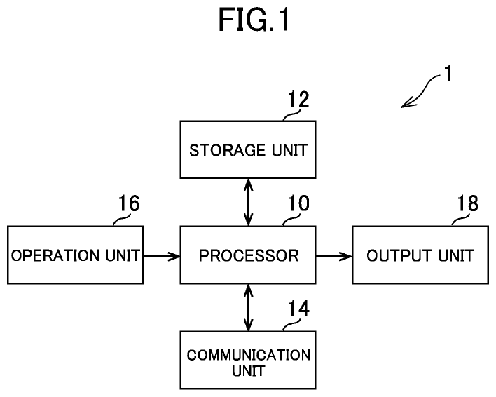

FIG. 1 is a diagram for illustrating an example of an overall configuration of the information processing system 1 according to the one embodiment of the present invention. As illustrated in FIG. 1, the information processing system 1 according to this embodiment is a computer, such as a server computer or a personal computer, and includes a processor 10, a storage unit 12, a communication unit 14, an operation unit 16, and an output unit 18. The information processing system 1 according to this embodiment may include a plurality of computers.

The processor 10 is, for example, a program-controlled device, such as a microprocessor, which operates in accordance with a program installed in the information processing system 1. The information processing system 1 may include one or a plurality of processors 10. The storage unit 12 is, for example, a storage element, such as a ROM or a RAM, a hard disk drive (HDD), or a solid-state drive (SSD) including a flash memory. The storage unit 12 stores, for example, a program to be executed by the processor 10. The communication unit 14 is a communication interface for wired communication or wireless communication, such as a network interface card, and exchanges data with another computer or terminal through a computer network, such as the Internet.

The operation unit 16 is an input device, and includes, for example, a pointing device, such as a touch panel or a mouse, or a keyboard. The operation unit 16 transmits operation content to the processor 10. The output unit 18 is an output device, for example, a display such as a liquid crystal display unit or an organic EL display unit, or an audio output device such as a speaker.

Programs and data to be described as being stored into the storage unit 12 may be supplied thereto from another computer via the network. Further, the hardware configuration of the information processing system 1 is not limited to the above-mentioned example, and various types of hardware can be applied thereto. For example, the information processing system 1 may include a reading unit (for example, an optical disc drive or a memory card slot) which reads a computer-readable information storage medium, or an input/output unit (for example, a USB port) for inputting and outputting data to/from an external device. For example, the program and the data stored in the information storage medium may be supplied to the information processing system 1 through intermediation of the reading unit or the input/output unit.

The information processing system 1 according to this embodiment detects a user (person) having personal information which is required to be changed but has not been updated. In order to achieve this, the information processing system 1 uses a type of a relation and a proximity between a user to be detected (hereinafter also referred to as “person of interest”) and a user having a relationship with that user (hereinafter also referred to as “reference person”), and a change status of personal information on the reference person. As used herein, “change status of personal information” is information relating to a change in the personal information, which may include, for example, a history of changes to the personal information in one service, information indicating a presence/absence or a timing of registration or a change in the personal information in one service, a commonality in the personal information among a plurality of different services associated with the same user, and other types of information.

Now, functions of the information processing system 1 according to this embodiment and processing to be executed by the information processing system 1 are further described.

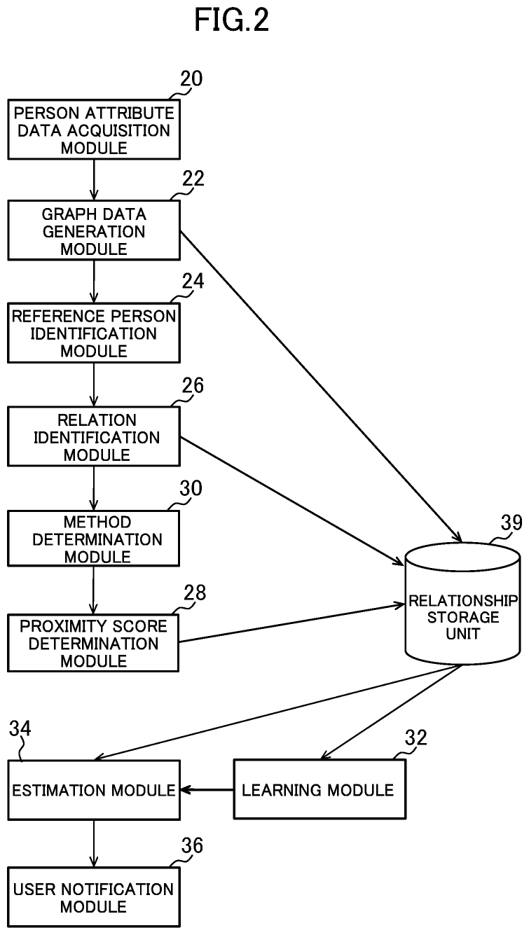

FIG. 2 is a functional block diagram for illustrating an example of the functions implemented by the information processing system 1 according to this embodiment. In the information processing system 1 according to this embodiment, not all the functions illustrated in FIG. 2 are required to be implemented, and a function other than the functions illustrated in FIG. 2 may be implemented.

As illustrated in FIG. 2, the information processing system 1 according to this embodiment functionally includes a person attribute data acquisition module 20, a graph data generation module 22, a reference person identification module 24, a relation identification module 26, a method determination module 30, a proximity score determination module 28, a learning module 32, an estimation module 34, a user notification module 36, and a relationship storage unit 39.

The person attribute data acquisition module 20, the graph data generation module 22, the reference person identification module 24, the relation identification module 26, and the proximity score determination module 28 are mainly functions for creating a social graph which includes pairs of users and relationships between the users in those pairs. The estimation module 34 is a function for estimating whether or not updating of the personal information on the person of interest is required (estimating update necessity), and the learning module 32 is a function for training a machine learning model (update necessity estimation model) used by the estimation unit 34.

The person attribute data acquisition module 20 and the user notification module 36 are implemented mainly by the processor 10, the storage unit 12, and the communication unit 14. The graph data generation module 22, the reference person identification module 24, the relation identification module 26, the method determination module 30, the proximity score determination module 28, and the estimation module 34 are implemented mainly by the processor 10 and the storage unit 12. The relationship storage unit 39 is implemented mainly by the storage unit 12.

The above-mentioned functions may be implemented by the processor 10 executing programs including execution instructions corresponding to the above-mentioned functions, which are installed in the information processing system 1 being a computer. The programs may also be supplied to the information processing system 1, for example, through a computer-readable information storage medium, such as an optical disc, a magnetic disk, or a flash memory, or through the Internet or the like.

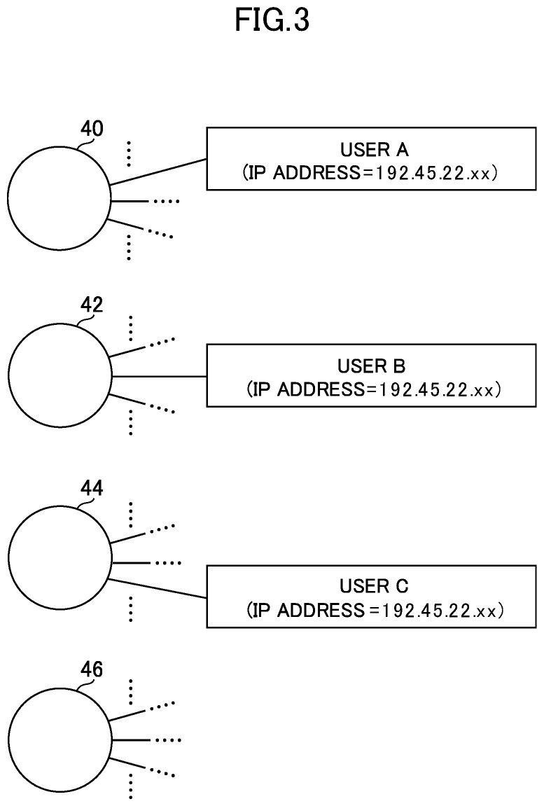

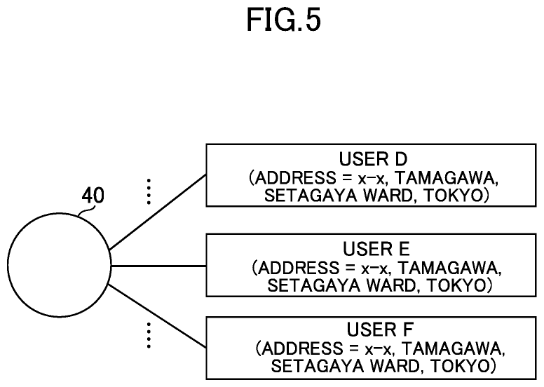

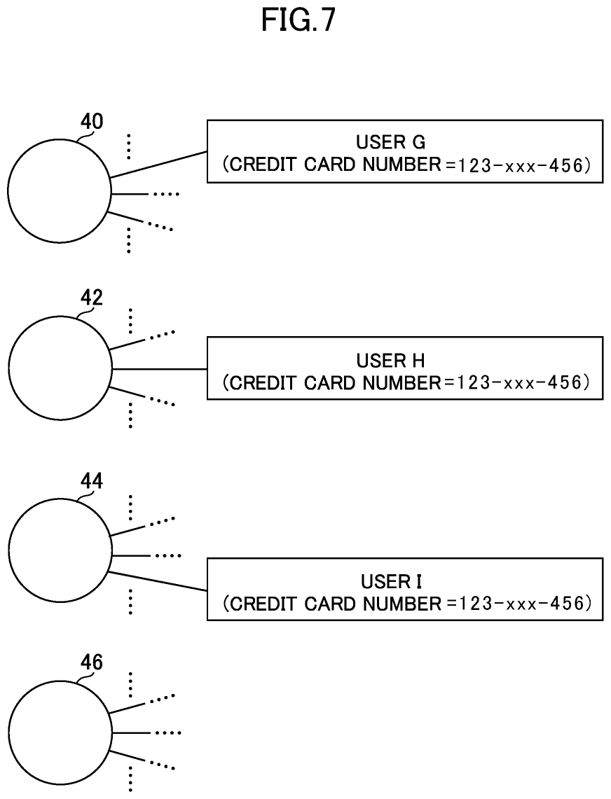

The information processing system 1 according to this embodiment can communicate to and from a plurality of computer systems such as an electronic commerce transaction system 40, a golf course reservation system 42, a travel reservation system 44, and a card management system 46, for example (see FIG. 3, FIG. 5, and FIG. 7). In each of those computer systems, account data, which is information relating to the users using the computer system, is registered. The information processing system 1 can access those computer systems and acquire the account data registered in the computer system.

The account data includes, for example, a user ID, full name data, street address data, age data, gender data, telephone number data, mobile phone number data, credit card number data, IP address data, and the like.

The user ID is, for example, identification information on the user in the computer system. The full name data is, for example, data indicating the full name (family name (surname) and given name) of the user. The street address data is, for example, data indicating the street address of the user. When the computer system is the electronic commerce transaction system 40, the street address data may indicate the street address of a delivery destination of the product purchased by the user. The age data is, for example, data indicating the age of the user. The gender data is, for example, data indicating the gender of the user. The telephone number data is, for example, data indicating the telephone number of the user. The mobile phone number data is, for example, data indicating the mobile phone number of the user. The credit card number data is, for example, data indicating the card number of the credit card used by the user for payment in the computer system. The IP address data is, for example, data indicating the IP address of the computer used by the user (for example, the IP address of the sender).

In this embodiment, for example, the person attribute data acquisition module 20 acquires person attribute data indicating an attribute of each of a plurality of persons, including the person of interest. An example of the person attribute data is the above-mentioned account data. The person attribute data acquisition module 20 acquires the account data, for example, of the person from each of the above-mentioned plurality of systems.

In this embodiment, for example, the graph data generation module 22 identifies pairs of persons having a relationship with each other based on the attributes of each of the plurality of persons. The graph data generation module 22 may identify a pair of persons having a relationship with each other based on the person attribute data of the plurality of persons. The graph data generation module 22 in this embodiment corresponds to an example of pair identification means for identifying a pair of persons having a relationship with each other based on an attribute of each of a plurality of persons, which is recited in the claims.

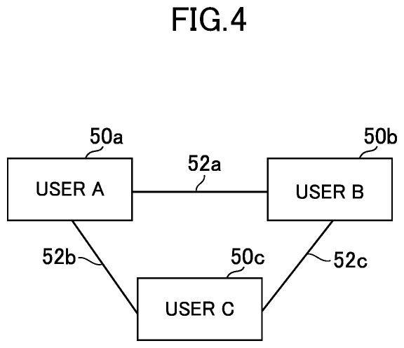

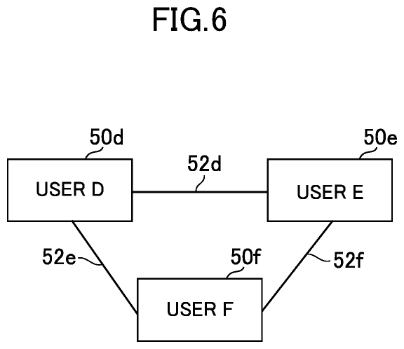

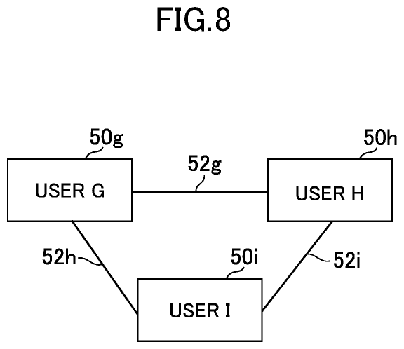

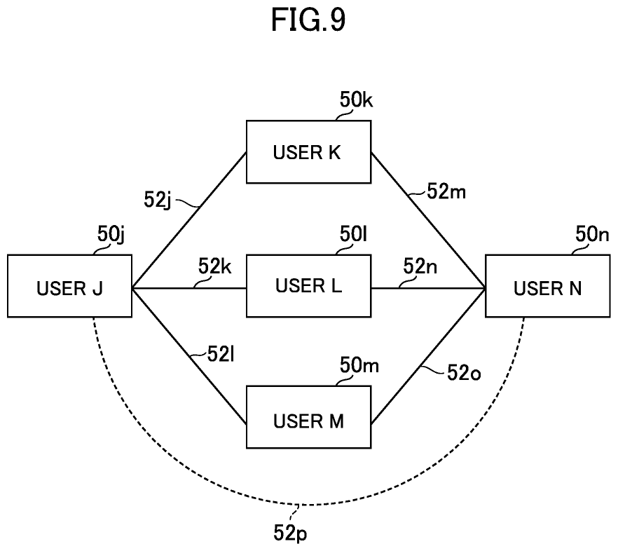

The graph data generation module 22 generates graph data including, for example, node data 50 associated with each of a plurality of persons including the person of interest and link data 52 associated with pairs of persons having a relationship with each other (see FIG. 4, FIG. 6, FIG. 8, and FIG. 9). The graph data generation module 22 stores the generated graph data in the relationship storage unit 39.

For example, as illustrated in FIG. 3, it is assumed that the account data of a user A is registered in the electronic commerce transaction system 40, the account data of a user B is registered in the golf course reservation system 42, and the account data of a user C is registered in the travel reservation system 44.

Further, it is assumed that the value of the IP address data of the user A registered in the electronic commerce transaction system 40, the value of the IP address data of the user B registered in the golf course reservation system 42, and the value of the IP address data of the user C registered in the travel reservation system 44 are the same.

In this case, as illustrated in FIG. 4, the graph data generation module 22 generates graph data including node data 50a associated with the user A, node data 50b associated with the user B, node data 50c associated with the user C, link data 52a indicating that the user A has a relationship with the user B, link data 52b indicating that the user A has a relationship with the user C, and link data 52c indicating that the user B has a relationship the with user C.

Users having the same IP address are presumed to be using the same computer. Thus, in this embodiment, such users are associated with each other.

Further, for example, as illustrated in FIG. 5, it is assumed that the account data of a user D, a user E, and a user F are registered in the electronic commerce transaction system 40.

Then, it is assumed that the value of the street address data of the user D, the value of the street address data of the user E, and the value of the street address data of the user F registered in the electronic commerce transaction system 40 are the same.

In this case, as illustrated in FIG. 6, the graph data generation module 22 generates graph data including node data 50d associated with the user D, node data 50e associated with the user E, node data 50f associated with the user F, link data 52d indicating that the user D has a relationship with the user E, link data 52e indicating that the user D has a relationship with the user F, and link data 52f indicating that the user E has a relationship the with user F.

Users having the same street address are presumed to be living together. Thus, in this embodiment, such users are associated with each other.

Further, for example, as illustrated in FIG. 7, it is assumed that the account data of a user G is registered in the electronic commerce transaction system 40, the account data of a user H is registered in the golf course reservation system 42, and the account data of a user I is registered in the travel reservation system 44.

Further, it is assumed that the value of the credit card number data of the user G registered in the electronic commerce transaction system 40, the value of the credit card number data of the user H registered in the golf course reservation system 42, and the value of the credit card number data of the user I registered in the travel reservation system 44 are the same.

In this case, as illustrated in FIG. 8, the graph data generation module 22 generates graph data including node data 50g associated with the user G, node data 50h associated with the user H, node data 50i associated with the user I, link data 52g indicating that the user G has a relationship with the user H, link data 52h indicating that the user G has a relationship with the user I, and link data 52i indicating that the user H has a relationship the with user I.

Users having the same credit card number are presumed to be a family, for example, a parent and child. Thus, in this embodiment, such users are associated with each other.

It should be noted that the criteria for determining whether or not a person corresponds to a pair of persons having a relationship with each other are not limited to the criteria described above.

Further, the above-mentioned links indicated by the link data 52 associating the persons identified as having a relationship with each other are referred to as “explicit links.”

In this case, for example, it is assumed that there are a predetermined number or more of persons in common (for example, three persons or more) between the persons connected to a first person by an explicit link and the persons connected to a second person by an explicit link. In this case, in this embodiment, for example, the graph data generation module 22 generates link data 52 indicating that those first persons have a relationship with those second persons. A link indicated by the link data 52 generated in this way is referred to as “implicit link.”

For example, as illustrated in FIG. 9, it is assumed that node data 50j associated with a user J and node data 50k associated with a user K are connected by link data 52j indicating an explicit link, the node data 50j associated with the user J and node data 501 associated with a user L are connected by link data 52k indicating an explicit link, and the node data 50j associated with the user J and node data 50m associated with a user M are connected by link data 521 indicating an explicit link.

Further, it is assumed that the node data 50k associated with the user K and node data 50n associated with a user N are connected by link data 52m indicating an explicit link, the node data 501 associated with the user L and the node data 50n associated with the user N are connected by the link data 52n indicating an explicit link, and the node data 50m associated with the user M and the node data 50n associated with the user N are connected by link data 52o indicating an explicit link.

In this case, the graph data generation module 22 generates link data 52p (link data 52p indicating an implicit link) indicating that the user J has a relationship with the user N. In this way, the user N is identified as a person having a relationship with the user J.

Further, for example, it is assumed that there are a predetermined number or more of persons in common (for example, three persons or more) between the persons connected to a first person by an explicit link or an implicit link and the persons connected to a second person by an explicit link or an implicit link. In this case, the graph data generation module 22 may generate link data 52 (link data 52 indicating an implicit link) indicating that those first persons have a relationship with those second persons.

The graph data generation module 22 may generate graph data based on person attribute data different from the account data.

The reference person identification module 24 identifies a reference person, who is a person having a relationship with a processing target person (including the person of interest, for example). In this case, the reference person identification module 24 may identify, as a reference person, a person identified as a person having a relationship with the processing target person (for example, a person registered as a friend in the electronic commerce transaction system 40 or the like), and a person having a predetermined number of persons or more of persons (for example, registered friends) identified as persons having a relationship in common with the processing target person. Further, the reference person identification module 24 may identify, based on an attribute of the processing target person and an attribute of a plurality of persons, the reference person from among the plurality of persons.

For example, the reference person identification module 24 may identify a person associated with node data 50 connected by link data 52 indicating an explicit link or an implicit link to the node data 50 associated with the processing target person as a reference person for the processing target person.

The relation identification module 26 identifies the relation between the processing target person (including the person of interest, for example) and the reference person. In this case, the relation identification module 26 may identify the relation between the processing target person and the reference person based on the account data of the processing target person and the account data of the reference person. In this case, the computer system in which the account data of the processing target person is registered may be different from the computer system in which the account data of the reference person is registered. For example, the relation (more specifically, the type of the relation) between the processing target person and the reference person may be identified based on the account data of the processing target person registered in the electronic commerce transaction system 40 and the account data of the reference person registered in the golf course reservation system 42. The relation identification module 26 may store the identified relation in the relationship storage unit 39 in association with the pair of the processing target person and the reference person.

Further, the relation identification module 26 may identify a family relationship (for example, parent-child, spouse, sibling) between the processing target person and the reference person. Moreover, the relation identification module 26 may select any one candidate including at least part of parent-child, spouse, sibling, colleague, neighbor, and friend as the type of the relation to be identified.

Next, processing of the relation identification module 26 is described in more detail. The relation identification module 26 identifies pairs of node data 50 connected by link data 52, for example. Then, the relation identification module 26 generates pair attribute data associated with each pair based on the person attribute data of the two persons associated with the pair.

The pair attribute data includes, for example, a common IP flag, a common street address flag, a common credit card number flag, a same-surname flag, age difference data, pair gender data, and the like.

The common IP flag is, for example, a flag indicating whether or not the value of the IP address data included in the account data of one person in the pair is the same as the value of the IP address data included in the account data of the other person in the pair. For example, when the values of the IP address data are the same on a given day, the value of the common IP flag may be set to 1, and when values of the IP address data are different, the value of the common IP flag may be set to 0. The pair attribute data relating to the processing target person and the reference person may include information indicating the type of the relation which is identified by the relation identification module 26 and which relates to the pair of the processing target person and the reference person.

The common street address flag is, for example, a flag indicating whether or not the value of the street address data included in the account data of one person in the pair is the same as the value of the street address data included in the account data of the other person in the pair. For example, when the values of the street address data are the same, the value of the common street address flag may be set to 1, and when the values of the street address data are different, the value of the common street address flag value may be set to 0.

The common credit card number flag is, for example, a flag indicating whether or not the value of the credit card number data included in the account data of one person in the pair is the same as the value of the credit card number data included in the account data of the other person in the pair. For example, when the values of the credit card number data are the same, the value of the common credit card number flag may be set to 1, and when the values of the credit card number data are different, the value of the common credit card number flag value may be set to 0.

The same-surname flag is, for example, a flag indicating whether or not the surname indicated by the full name data included in the account data of one person in the pair is the same as the surname indicated by the full name data included in the account data of the other person in the pair. For example, when the surnames indicated by the full name data are the same, the value of the same-surname flag may be set to 1, and when the surnames indicated by the full name data are different, the value of the same-surname flag value may be set to 0.

The age difference data is, for example, data indicating the difference between the value of age data included in the account data of one person in the pair and the value of age data included in the account data of the other person in the pair.

The pair gender data is, for example, data indicating the combination of the value of gender data included in the account data of one person in the pair and the value of gender data included in the account data of the other person in the pair.

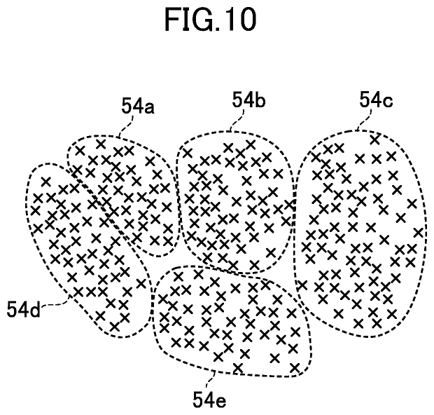

Further, the relation identification module 26 classifies a plurality of pairs into a plurality of clusters 54 like those illustrated in FIG. 10 by executing clustering using a general clustering method based on the values of the pair attribute data associated with each of the plurality of pairs.

FIG. 10 is a diagram for schematically illustrating an example of how a plurality of pairs are classified into five clusters 54 (54a, 54b, 54c, 54d, and 54e). The cross marks illustrated in FIG. 10 correspond to pairs. Each of the plurality of cross marks is arranged at a position associated with the value of the pair attribute data of the pair corresponding to the cross mark.

In the example of FIG. 10, a plurality of pairs are classified into five clusters 54, but the number of clusters 54 into which a plurality of pairs are classified is not limited to five. For example, the plurality of pairs may be classified into four clusters 54.

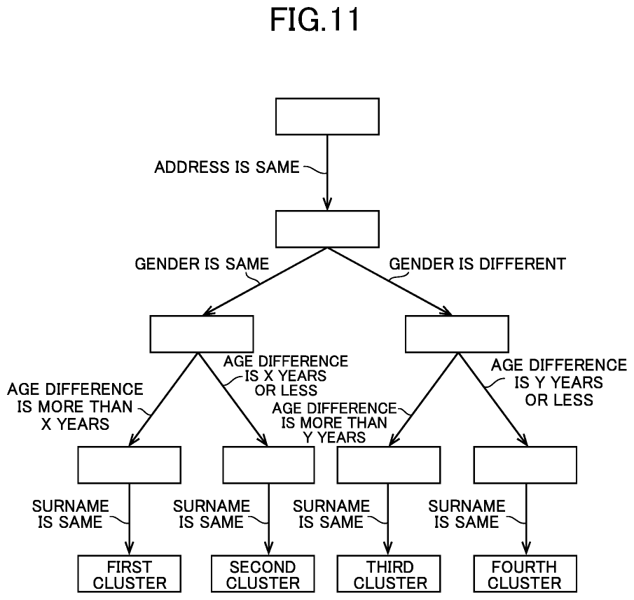

FIG. 11 is a diagram for illustrating an example of visualization of the classification in the case in which a plurality of pairs are classified into four clusters 54.

As illustrated in FIG. 11, pairs having the same street address, the same gender, an age difference of more than X years, and the same surname may be classified into a first cluster. Pairs having the same street address, the same gender, an age difference of X years or less, and the same surname may be classified into a second cluster. Pairs having the same street address, different genders, an age difference of more than Y years, and the same surname may be classified into a third cluster. Pairs having the same street address, different genders, an age difference of Y years or less, and the same surname may be classified into a fourth cluster.

In this case, the first cluster is presumed to be, for example, a cluster 54 associated with a parent-child pair of the same gender. The second cluster is presumed to be, for example, a cluster 54 associated with siblings of the same gender. The third cluster is presumed to be, for example, a cluster 54 associated with a parent-child pair of the opposite gender. The fourth cluster is presumed to be, for example, a cluster 54 associated with a married couple or siblings of the opposite gender.

In the way described above, the relation identification module 26 may identify the relation between the processing target person and the reference person based on the results of clustering performed based on values associated with the relationship between the persons. Further, the relation identification module 26 may identify the relation between the processing target person and the reference person based on the results of clustering performed based on at least one of the surname, the IP address, the street address, the credit card number, the age difference, or the gender.

The proximity score determination module 28 determines a proximity score indicating the proximity between the processing target person and the reference person based on a determination criterion corresponding to the relation between the processing target person and the reference person and an index indicating the strength of the relationship between the processing target person (including the person of interest, for example) and the reference person.

The method determination module 30 determines a determination criterion corresponding to the type selected as the relation between the processing target person and the reference person. More specifically, the method determination module 30 may determine, as the determination criterion, a machine learning model (proximity score determination model) for proximity score determination to be used by the proximity score determination module 28.

The proximity score determination module 28 then determines, in accordance with the determined determination criterion, a proximity score indicating the proximity between the processing target person and the reference person based on the index indicating the strength of the relationship between the processing target person and the reference person. The proximity score determination module 28 stores the determined proximity score in the relationship storage unit 39 in association with the pair of the processing target person and the reference person.

In this case, the proximity score determination module 28 may include trained machine learning models (proximity score determination models) associated with the respective clusters 54 described above. For example, when a plurality of pairs are classified into five clusters 54, the proximity score determination module 28 may include five machine learning models.

Further, the proximity score determination module 28 may determine the proximity score indicating the proximity between the processing target person and the reference person based on an output of the trained machine learning model (proximity score determination model) obtained when data representing the index indicating the strength of the relationship between the processing target person and the reference person is input to the trained machine learning model, in which the trained machine learning model corresponds to the relation between the processing target person and the reference person.

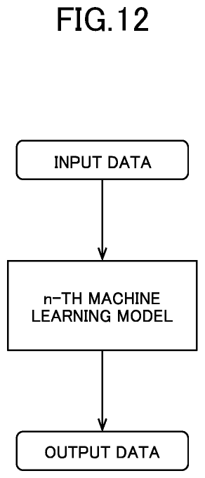

As illustrated in FIG. 12, the proximity score determination module 28 may input, to an n-th machine learning model, input data corresponding to the pair classified into the cluster 54 associated with the n-th machine learning model. For example, when the proximity score determination module 28 includes five machine learning models, the value of “n” is any integer between 1 and 5 inclusive thereof. The proximity score determination module 28 may determine the value of the output data to be output from the n-th machine learning model in response to the input of the input data as the value of the proximity score for the pair.

The input data associated with the pair may include, for example, a part or all of the pair attribute data associated with the pair. Further, the input data may include data which is not included in the pair attribute data. For example, the input data may include data indicating a usage history of the electronic commerce transaction system 40, data acquired from another information source such as an SNS by the proximity score determination module 28, and the like. More specifically, for example, the input data may include data indicating the number of phone calls (phone call frequency) or the number of messages exchanged per unit period for the pair, the number of gifts sent by one member of the pair to the other, the number of common (registered) friends for the pair, and the like.

The type of the data included in the input data associated with the pair may be the same or different depending on the cluster 54 to which the pair belongs. For example, the type of the data included in the input data input to a first machine learning model may be different from the type of the data included in the input data input to a second machine learning model.

In this embodiment, for example, before the determination of the proximity score by the proximity score determination module 28, training of the n-th machine learning model is executed in advance by using a given number of a plurality of pieces of training data associated with the n-th machine learning model. The training data is, for example, prepared in advance so that the determination of the proximity score for the cluster 54 associated with the n-th machine learning model is appropriate.

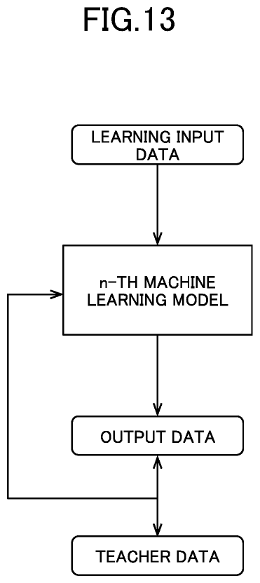

In this case, weakly supervised learning may be performed on the n-th machine learning model. For example, the training data may include, as illustrated in FIG. 13, learning input data including data of the same type as that of the input data input to the n-th machine learning model and teacher data (ground truth data) to be compared with the output data output from the n-th machine learning model in response to the input of the learning input data.

For example, it is assumed that the above-mentioned proximity score has a value of any one of 0 or 1, and that the value of the proximity score of the pair is determined to be “1” when the pair is in a close relationship and “0” when the pair is not in a close relationship.

In this case, the teacher data may include a proximity score value appropriate for the corresponding learning input data, and data indicating the probability that this value is appropriate.

Further, for example, weakly supervised learning for updating the value of a parameter of the n-th machine learning model may be executed based on the value of the output data output from the n-th machine learning model in response to the input of the learning input data included in the training data and the value of the teacher data included in the training data.

It is not required that the above-mentioned proximity score be binary data having a value of any one of 0 or 1. For example, the above-mentioned proximity score may be a real number (for example, a real number of 0 or more and 10 or less) which becomes a larger value as the pair becomes closer, or a multi-step integer value (for example, an integer value of 1 or more and 10 or less).

Further, the learning method of the machine learning model (proximity score determination model) is not limited to weakly supervised learning.

As a specific example, there may be a case in which the pair has a sibling relationship. In this case, the input data associated with the pair is input to the trained machine learning model corresponding to the sibling relationship. Further, for example, when the pair have the same street address data values, the number of gifts sent from one of the pair to the other is 50, and the number of phone calls that the pair has made so far is 1,200, then training may be executed such that output data having the value “1” is output. Further, for example, when the pair have different address data values, the number of gifts sent from one of the pair to the other is 2, and the number of phone calls that the pair has made so far is 30, then training may be executed such that output data having the value “0” is output.

The determination criterion (for example, threshold value) for determining whether the value of the output data corresponding to the proximity score is 1 or 0 may differ depending on the machine learning model (proximity score determination model).

The estimation module 34 estimates whether or not the personal information on the person of interest is required to be updated based on input data including an attribute of the person of interest, an attribute of the reference person, and the type of the relation and the proximity score for the pair of the person of interest and the reference person. In the following description, estimating whether or not the personal information is required to be updated is referred to as “estimating update necessity.” The estimation module 34 may acquire, from the relationship storage unit 39, the type of the relation identified by the relation identification module 26 and the proximity score determined by the proximity score determination module 28 for the pair of the person of interest and the reference person. The attribute of the reference person includes gender, age, information indicating whether any of the postal code, street address, or telephone number, for example, has been updated in the last few days, and a behavioral history (for example, a purchase status or a browsing history of furniture or miscellaneous goods). The attribute of the person of interest also includes the information described above. Further, the estimation module 34 may estimate the probability based on at least part of the pair attribute data instead of the type of the relation of the pair.

The estimation module 34 may estimate the update necessity by using a machine learning model (update necessity estimation model). More specifically, the estimation module 34 may estimate the update necessity based on the output of the update necessity estimation model obtained when the input data is input to the update necessity estimation model. The update necessity estimation model may be a machine learning model implemented by, for example, machine learning such as AdaBoost, a random forest, a neural network, a support vector machine (SVM), a nearest neighbor classifier, and the like. Further, a machine learning model using so-called deep learning may be constructed as the update necessity estimation model.

The learning module 32 trains the update necessity estimation model by using training data including an attribute of a referral requestee, an attribute of a referral recipient, the type of the relation and the proximity score determined for the pair of the referral requestee and the referral recipient, and ground truth data indicating whether or not the personal information has been updated. Details of the processing of the learning module 32 are described later.

The user notification module 36 transmits, based on the estimation result obtained by the estimation module 34, a notification prompting the person of interest to confirm and update his or her personal information. For example, when a degree of update necessity (corresponding to an update necessity score) estimated by the estimation module 34 is equal to or more than a predetermined threshold value, the user notification module 36 may transmit a message prompting the person of interest to confirm and update his or her personal information to the email address or messenger address of the person of interest. The message may include a link to a web page on which the personal information can be confirmed and updated.

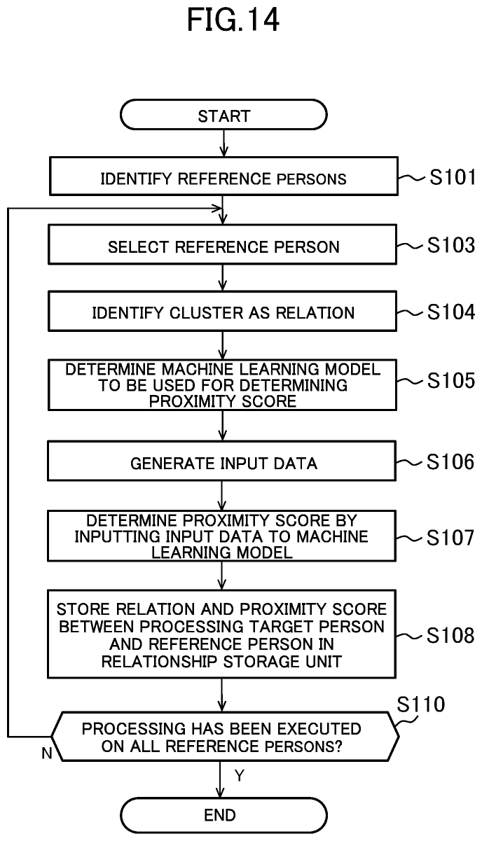

An example of processing for creating information relating to a social graph performed by the information processing system 1 according to this embodiment is now described with reference to a flow chart illustrated in FIG. 14. In FIG. 14, there is illustrated processing of mainly the reference person identification module 24, the relation identification module 26, and the proximity score determination module 28.

The processing illustrated in FIG. 14 is repeatedly executed for each person for which graph data has been generated. Graph data is generated for people including the person of interest. The person that is the target of the processing of FIG. 14 is hereinafter referred to as “processing target person.” In the processing example of FIG. 14, it is assumed that graph data for a plurality of persons, including the person of interest, has already been generated, and the clusters 54 associated with a plurality of pairs have been identified. It is also assumed that a machine learning model (proximity score determination model) associated with each cluster 54 has already been trained.

First, the reference person identification module 24 identifies, as reference persons, persons corresponding to the node data 50 connected by an explicit or implicit link to the node data 50 corresponding to the processing target person (Step S101). In this case, for example, it is assumed that at least one reference person is identified.

Then, the relation identification module 26 selects one reference person for which the processing steps of Step S104 to Step S108 have not yet been executed from among the reference persons identified in the processing step of Step S101 (Step S103).

Then, the relation identification module 26 identifies the cluster 54 corresponding to the pair of the processing target person and the reference person selected in the processing step of Step S102 as the type of the relation of that pair (Step S104).

The method determination module 30 determines the machine learning model to be used for determining the proximity score based on the identified type of the relation (Step S105).

Then, the proximity score determination module 28 generates input data corresponding to the pair of the processing target person and the reference person selected in the processing step of Step S104 (Step S106).

Then, the proximity score determination module 28 inputs, to the trained machine learning model associated with the cluster 54 identified in the processing step of Step S104, the input data generated in the processing step of Step S106 (Step S107). Then, the proximity score determination module 28 determines the value of the proximity score associated with the pair of the person of interest and the reference person based on the output data output from the machine learning model in response to the input (Step S107). Further, the relation identification module 26 stores the relation between the processing target person and the reference person in the relationship storage unit 39, and the proximity score determination module 28 stores the proximity score between the processing target person and the reference person in the relationship storage unit 39 (Step S108).

Then, the relation identification module 26 checks whether the processing steps of Step S104 to Step S108 have been executed for all the reference persons identified in the processing step of Step S101 (Step S110).

When the processing steps of Step S104 to Step S108 have not been executed for all of the reference persons identified in the processing step of Step S101 (“N” in Step S110), the process returns to the processing step of Step S103.

When the processing steps of Step S104 to Step S108 have been executed for all of the reference persons identified in the processing step of Step S101 (“Y” in Step S110), the processing of FIG. 14 is ended.

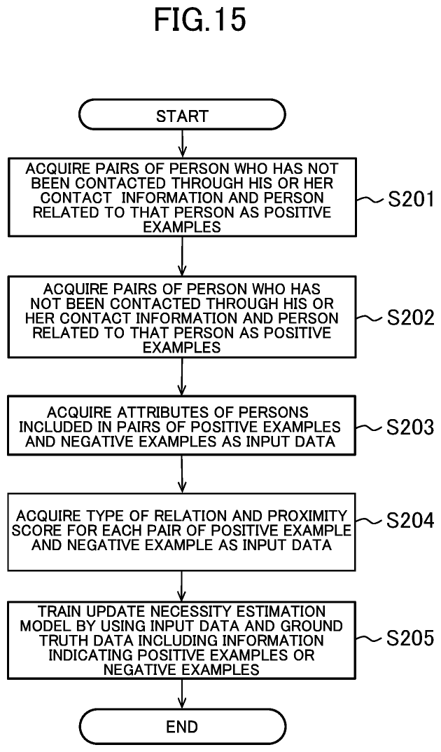

Next, an example of processing relating to the training of the machine learning model (update necessity estimation model) by the learning module 32, which is performed after the information on the social graph is created, is described with reference to a flow chart illustrated in FIG. 15.

First, the learning module 32 acquires, as positive examples, pairs of a person (user) who has not been contacted through his or her contact information and a person related to that person, which are stored in the storage unit 12 of the information processing system 1 (Step S201). The person acquired as positive examples together with the person who has not been contacted may be a person who is related to the person who has not been contacted and who has contact information which has been updated, or a relative such as a spouse, a parent, a child, or a sibling. As used herein, “person who has not been contacted” may refer to, for example, a person for which a notification has been received by an external service that a piece of postal mail addressed to the street address included in the personal information has been returned, a person who, after the piece of postal mail was sent to the street address included in the personal information, did not follow the directions (instructions), for example, accessing a URL or inputting a code, written in the piece of postal mail within a predetermined period of time, or some other type of person. The determination regarding whether or not to acquire a pair of a person who has not been contacted and a person related to that person as a positive example may be performed based on whether or not there is a difference in the contact information between the persons.

Next, the learning module 32 acquires, as negative examples, pairs of a person who has been contacted through his or her contact information and a person related to that person, which are stored in the storage unit 12 of the information processing system 1 (Step S202). The person acquired as negative examples together with the person who has been contacted is person who have a relationship with the contacted person, and may be any one of a person having contact information which has been updated or a person having contact information which has not been updated. As used herein, “person who has been contacted” refers to person who is the opposite to the above-mentioned examples of the person who has not been contacted.

When the positive examples and the negative examples have been acquired, the learning module 32 acquires, as part of the input data, attributes of the persons included in the pairs in the positive examples and the negative examples (Step S203). For the positive examples, the learning module 32 acquires information on each of the person who has not been contacted as a first person and a person having a relationship with that person as a second person, and for the negative examples, acquires information on each of the person who has been contacted as a first person and a person having a relationship with that person as a second person. Examples of the attributes of the persons include the age of the person, a reward point usage status, and a usage pattern of each service.

The learning module 32 also acquires, as part of the input data, the type of the relation and the proximity score for pairs in each of a positive example and a negative example (Step S204). The learning module 32 may further acquire, as the input data, another index indicating the strength of a relationship, for example, a frequency of phone calls between the first person and the second person and a frequency of sending gifts between the first person and the second person.

The learning module 32 trains the update necessity estimation model by using the input data including the attribute of the first person, the attribute of the second person, the type of the relation between the first person and the second person, and the proximity score between the first person and the second person, and ground truth data including the information indicating positive examples or negative examples (Step S205). The update necessity estimation model is trained such that the same result is not always output when the first person and the second person are replaced. When the input data having the person of interest as the first person and the reference person as the second person is input to the trained update necessity estimation model, the update necessity estimation model outputs information (update necessity score) indicating whether or not the personal information on the person of interest is required to be updated.

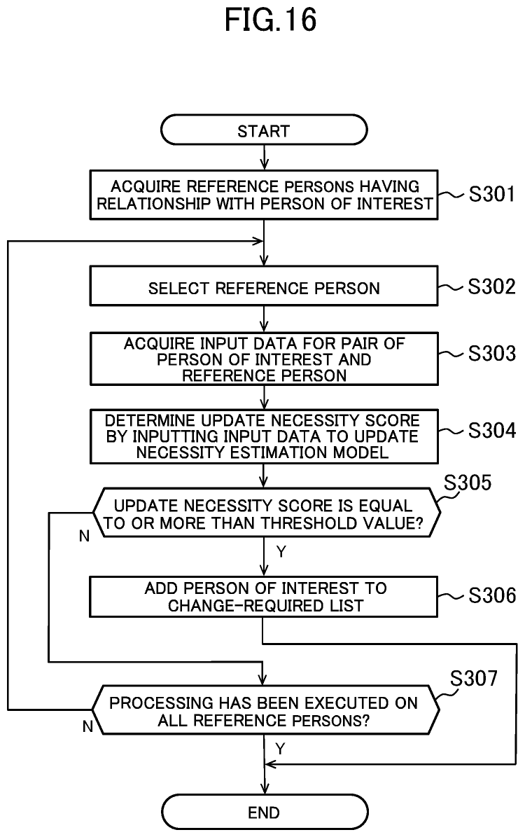

Next, an example of the processing of the estimation module 34 estimating the update necessity and the user notification module 36 making the request, which is performed after the update necessity estimation model has been trained, is described with reference to a flow chart illustrated in FIG. 16. The processing illustrated in FIG. 16 is executed for the person of interest for which update necessity is to be determined. When there are a plurality of persons of interest for which update necessity is to be determined, the processing illustrated in FIG. 16 is executed for each person of interest.

First, the estimation module 34 acquires reference persons who have a relationship with the person of interest (Step S301). Specifically, the estimation module 34 may acquire, as the reference persons, persons who correspond to the node data 50 connected by an explicit link or an implicit link to the node data 50 corresponding to the processing target person, and who have a family relationship, for example, spouse, parent-child, or sibling, as the relationship. Moreover, at least one reference person may be acquired.

Then, the estimation module 34 selects one reference person for which the processing steps of Step S303 and Step S304 have not yet been executed from among the reference persons identified in the processing step of Step S301 (Step S302).

When a reference person has been selected, the estimation module 34 acquires the input data for the pair of the person of interest and the selected reference person (Step S303). The input data includes an attribute of the person of interest (including an update status of personal information), an attribute of the reference person (including an update status of personal information), the type of the relation between the person of interest and the reference person, and the proximity score between the person of interest and the reference person. The input data may further include another index indicating the strength of the relationship, for example, the frequency of phone calls between the person of interest and the reference person and the frequency of sending gifts between the person of interest and the reference person. The update status of the personal information is information relating to a change in the personal information (for example, any of postal code, street address, or telephone number) registered in any computer system. Specifically, the update status of the personal information may be information relating to whether or not the registered personal information has been updated during the past N days. Further, the update status may be acquired based on a change status of the personal information stored in any computer system or the storage unit 12.

The estimation module 34 determines the update necessity score by acquiring the output of the update necessity estimation model obtained when the acquired input data is input to the update necessity estimation model (Step S304). The estimation module 34 may use the output of the update necessity estimation model as the update necessity score as it is, or may determine the update necessity score by performing a predetermined calculation on the output.

Then, the estimation module 34 determines whether or not the determined update necessity score satisfies a predetermined condition, specifically, whether the determined update necessity score is equal to or more than a threshold value (Step S305). When the update necessity score is equal to or more than the threshold value (“Y” in Step S305), the estimation module 34 adds the information on the person of interest to a change-required list (Step S306), and the processing of FIG. 16 for this person of interest is ended.

When the update necessity score is less than the threshold value (“N” in Step S305), the estimation module 34 confirms whether or not the processing steps of Step S303 to Step S305 have been executed for all of the reference persons identified in the processing step of Step S301 (Step S307).

When the processing steps of Step S303 to Step S305 have not been executed for all of the reference persons identified in the processing step of Step S301 (“N” in Step S307), the process returns to the processing step of Step S302.

When the processing steps of Step S303 to Step S305 have been executed for all of the reference persons identified in the processing step of Step S301 (“Y” in Step S307), the estimation module 34 ends the processing of FIG. 16 for this person of interest.

When the processing illustrated in FIG. 16 has been executed on the required person of interest, the user notification module 36 inquires of the person of interest included in the change-required list about the change status of the personal information, and transmits information prompting the person of interest to update their personal information.

For example, when a usage frequency of a computer system such as the electronic commerce transaction system 40 by the person of interest is low, the person is less likely to change his or her personal information when he or she moves house. However, when the spouse (corresponding to the reference person) of the person of interest has a high frequency usage of the computer system and the personal information has been updated, the update necessity estimation model estimates that the degree of update necessity (corresponding to the update necessity score) of the personal information on the person of interest is high. As a matter of course, when the person of interest and the reference person have both not updated their personal information and not performed the actions associated with moving, the update necessity estimation model estimates that the degree of update necessity of the personal information on the person of interest is low.

The estimation module 34 not only estimates that the personal information on the person of interest is required to be updated when the personal information on the reference person is updated, but also estimates that the personal information on the person of interest is not required to be updated even when the personal information on the reference person is updated.

For example, in a case in which the age of the reference person is 18, the relationship between the person of interest and the reference person is a parent-child relationship, and the street address of the reference person has been updated, it is highly likely that the reference person has started living alone. In such a case, the estimation module 34 may estimate that there is a low degree of necessity to update the personal information on the person of interest. Meanwhile, when the relationship between the person of interest and the reference person is a spouse, and the address of the reference person has been updated, there is a possibility that the person of interest has also moved. In such a case, the estimation module 34 may estimate that there is a high degree of necessity to update the personal information on the person of interest.

In this embodiment, the estimation module 34 determines, for a pair of a person of interest and a reference person, the update necessity by using not only the type of the relation between those persons but also a proximity score indicating the closeness between the persons. Further, the type of the relation, such as spouse or sibling, is determined for the pair of the person of interest and the reference person, and the proximity score for the pair is determined in accordance with the type of the relation. As a result, it is possible to estimate the update necessity more accurately.

Further, interactions between users, such as the frequency of phone calls between a person of interest and a reference person, or the frequency of sending gifts between a person of interest and a reference person, are also used to determine the proximity score. This enables the proximity score to be determined more accurately and the accuracy of the update necessity estimation to be improved.

It should be noted that the present invention is not limited to the embodiment described above and various modifications can be made thereto. For example, the data in the relationship storage unit 39 used by the learning module 32 to train the update necessity estimation model and the data in the relationship storage unit 39 used by the estimation module 34 to estimate the update necessity may be different. Between the training of the update necessity estimation model and the processing of the estimation module 34, the processing of each of the person attribute data acquisition module 20, the graph data generation module 22, the reference person identification module 24, the relation identification module 26, and the proximity score determination module 28 may be executed by using the latest information.

The recitations of the claims are intended to cover all such modifications as falling within the spirit and scope of the present invention. Further, the specific character strings and numerical values described above and the specific character strings and numerical values in the drawings are merely exemplary, and the present invention is not limited to those character strings and numerical values.

The invention claimed is:

1: An information processing system, comprising:
at least one processor; and
at least one memory device that stores a plurality of instructions which, when executed by the at least one processor, causes the at least one processor to:
identify a type of a relation between a person of interest and a reference person;
determine, in accordance with a determination criterion corresponding to the type of the relation between the person of interest and the reference person, a proximity score indicating a proximity between the person of interest and the reference person based on an index indicating a strength of a relationship between the person of interest and the reference person; and
estimate an update necessity of personal information on the person of interest based on input data including an attribute of the person of interest, an attribute of the reference person, a change status of personal information on the reference person, and the proximity score and the type of the relation for both the person of interest and the reference person.

2: The information processing system according to claim 1, wherein the instructions cause the at least one processor to estimate the update necessity by inputting the input data to an update necessity estimation model, which is a machine learning model trained by using training data including an attribute of a first person, an attribute of a second person, the type of the relation and the proximity score for both the first person and the second person, a change status of personal information on the second person, and ground truth data indicating whether personal information on the first person has been changed.

3: The information processing system according to claim 1, wherein the instructions cause the at least one processor to select, as the type of the relation, any one candidate from among candidates including at least part of parent-child, spouse, and sibling.

4: The information processing system according to claim 1, wherein the instructions cause the at least one processor to identify the type of the relation between the person of interest and the reference person based on at least part of whether a surname is the same, whether an IP address is the same, a similarity in street addresses, an age difference, and whether gender is the same.

5: The information processing system according to claim 1, wherein the instructions cause the at least one processor to determine the proximity score indicating the proximity between the person of interest and the reference person based on an output of a proximity score determination model, which is a machine learning model corresponding to the type of the relation between the person of interest and the reference person, the output obtained when the index indicating the strength of the relationship between the person of interest and the reference person is input to the proximity score determination model.

6: The information processing system according to claim 1, wherein the index indicating the strength of the relationship between the person of interest and the reference person includes at least part of whether the person of interest and the reference person have a same street address, whether the person of interest and the reference person share a credit card, a number of friends in common between the person of interest and the reference person, a frequency of phone calls between the person of interest and the reference person, and a frequency of sending gifts between the person of interest and the reference person.

7: The information processing system according to claim 1, wherein the instructions cause the at least one processor to identify the type of the relation between the person of interest and the reference person based on attribute data of the person of interest registered in a first computer system and attribute data of the reference person registered in a second computer system.

8: An information processing method, comprising:
identifying, with at least one processor operating with a memory device in a system, a type of a relation between a person of interest and a reference person;
determining, in accordance with a determination criterion corresponding to the type of the relation between the person of interest and the reference person, a proximity score indicating a proximity between the person of interest and the reference person based on an index indicating a strength of a relationship between the person of interest and the reference person with at least one processor operating with the memory device in the system; and
estimating, with at least one processor operating with the memory device in the system, an update necessity of personal information on the person of interest based on input data including an attribute of the person of interest, an attribute of the reference person, a change status of personal information on the reference person, and the proximity score and the type of the relation for both the person of interest and the reference person.

9: A non-transitory computer readable storage medium storing a plurality of instructions, wherein when executed by at least one processor, the plurality of instructions cause the at least one processor to:
identify a type of a relation between a person of interest and a reference person;
determine, in accordance with a determination criterion corresponding to the type of the relation between the person of interest and the reference person, a proximity score indicating a proximity between the person of interest and the reference person based on an index indicating a strength of a relationship between the person of interest and the reference person; and
estimate an update necessity of personal information on the person of interest based on input data including an attribute of the person of interest, an attribute of the reference person, a change status of personal information on the reference person, and the proximity score and the type of the relation for both the person of interest and the reference person.
